(19) United States
(12) Patent Application Publication
(10) Pub. No.: US 2002/0141572 A1
(43) Pub. Date: Oct. 3, 2002

(54) Detachable shoulder rest apparatus for telephone handsets

(76) Inventor: Gary Rogalski, Richmond (CA)

Correspondence Address: Howard E. Silverman, LAW OFFICES OF DICK AND HARRIS, 181 West Madison Street, Suite 3800, Chicago, IL, 60602, US

(21) Appl. No.: 09/825,227

(22) Filed: Apr. 3, 2001

(51) Int. Cl. H04M 1/00

(52) U.S. Cl. 379/449

(57) ABSTRACT

A detachable shoulder rest apparatus for use with a telephone handset is provided, which includes a body portion and at least one attachment member to removably attach the body portion to the exterior of the telephone handset. The body portion may comprise a contoured wedge which conforms to the shape of the user's shoulder, and may be either substantially rigid or deformable. The at least one attachment member may take the form of a plurality of arms extending from the body portion which engage one or more slots or recesses on the handset, a hook member which engages with one or more slots or apertures on the handset, or a slot or aperture which engages with one or more projections or protrusions on the telephone handset. In another embodiment, the detachable shoulder rest apparatus includes a base portion joining the body portion and the attachment members, which may be separable from the body portion.

### BACKGROUND OF THE INVENTION

1. Field of the Invention

The present invention relates in general to a detachable shoulder rest apparatus for use with telephone handsets and, in particular, to a detachable shoulder rest that utilizes an attaching mechanism for removably attaching the shoulder rest to a cordless telephone or other portable electronic communication device.

2. Background Art

Telephone handset shoulder rests are well known in the art. Shoulder rest attachments have long been an available option to telephone users, since it has been deemed desirable to provide a comfortable way of allowing a telephone handset to rest between the user's head and shoulder without having to hold onto the handset, thereby freeing up both of the user's hands to perform other functions and without inducing strain on the user's neck if forced to cock one's head to retain the handset between head and shoulder.

The prior art discloses the use of adhesive for permanently attaching a shoulder rest to a telephone handset, and specifically to the rear or outer facing surface of the handset. Typically the shoulder rest is sold to the consumer as an accessory and comes packaged with a strip of double-sided tape carrying the adhesive to glue the shoulder rest to the telephone handset. Such shoulder rests were intended for traditional telephone handsets that are, via a telephone cord, connected to a telephone base.

However, as time progresses, the adhesive material begins to lose its ability to hold the shoulder rest and telephone handset together. As a result, the shoulder rest begins to peal away from the handset, and eventually either falls off or is tom off by the user. When the shoulder rest is removed, intentionally or by effect of time and use, a coat of the adhesive material remains on the handset. This remaining adhesive material is difficult to remove, and becomes both unsightly and unsanitary.

Additionally, because of constant use, flexible shoulder rests begin to lose their ability to return to their original shape. As a result, the shoulder rest begins to flatten, causing usage of the shoulder rest to become difficult and uncomfortable. Since these shoulder rests are designed to be permanently affixed to the handset, the user must, if the shoulder rest has not yet peeled off, spend the time and energy tearing the shoulder rest from the handset and removing the remaining adhesive material. Only then may a replacement shoulder rest be securely attached.

A permanently adhered shoulder rest is undesirable when a user wishes to take advantage of the compact size and intended mobility of a cordless or portable phone. By permanently affixing a shoulder rest to cordless or portable telephone handset, the phone's inherent advantages are destroyed because the phone becomes bulky and cumbersome to carry. Additionally, some cordless telephones have keypads positioned on the handset where a shoulder rest would be located. Other models of cordless telephone handsets provide battery compartments through which one can access the rechargeable battery to replace it if necessary. A battery compartment door is often positioned on the rear facing surface of the cordless handset. An adhesively mounted shoulder rest would restrict or totally preclude access to the battery by effectively gluing it shut. In those situations a permanently attached shoulder rest is not a viable option.

It would be desirable to provide for a shoulder rest apparatus that may be used with cordless telephones, or other portable electronic communication devices, which is readily detachable from the telephone handset.

These and other objects of the present invention will become apparent to those of ordinary skill in the art in light of the present specifications, drawings and claims.

### SUMMARY OF THE INVENTION

The present invention is directed to a detachable shoulder rest apparatus for use with a telephone handset having one or more positions on the exterior of the telephone handset housing capable for accepting removable placement of telephone accessories. The detachable shoulder rest comprises of a body portion configured to rest against the user's shoulder for supporting the telephone handset between the user's shoulder and head and at least one attachment member for engaging with the telephone handset to removably attach the body portion to the exterior of the telephone handset.

In a preferred embodiment, the body portion may comprise a contoured wedge to substantially conform to the shape of the user's shoulder. In addition, the body portion may comprise a substantially rigid material or a deformable material capable of conforming to the shape of the user's shoulder.

In another preferred embodiment, the at least one attachment member comprises a plurality of arms extending from the body portion and configured so as to engage at least one slot or recess located on the telephone handset. In yet another embodiment, the at least one attachment member comprises at least one hook member configured so as to engage at least one slot or aperture located on the telephone handset. In still another embodiment, the at least one attachment member comprises at least one slot or aperture configured so as to engage at least one projection or protrusion located on the telephone handset.

Another preferred embodiment of the invention further comprises a base portion joining the body portion to the at least one attachment member. In this embodiment, the base portion and body portion may be separable from one another.

### BRIEF DESCRIPTION OF THE DRAWINGS

FIG. 1 is a perspective view of a detachable shoulder rest apparatus according to a preferred embodiment of the present invention, showing the shoulder rest apparatus detached from the telephone handset;

FIG. 2 is a perspective view of the detachable shoulder rest apparatus shown in FIG. 1, showing the shoulder rest apparatus attached to the telephone handset;

FIG. 3 is a cross-sectional view of the detachable shoulder rest apparatus shown in FIG. 1, showing the shoulder rest apparatus attached to the telephone handset by means of a plurality of arms extending from the body portion of the shoulder rest apparatus engaging a plurality of recesses located on the telephone handset;

FIG. 4 is a cross-sectional view of another preferred embodiment of the invention, showing the body portion and attachment member portions of the shoulder rest apparatus as combined into a single piece;

FIG. 5 is a perspective view of another embodiment of the invention, showing the attachment members as hook members attached to the bottom of the body portion of the shoulder rest apparatus, along with the slots adapted for receiving the hook members located on the back of the telephone handset.

### DETAILED DESCRIPTION OF THE INVENTION

While this invention is susceptible of embodiment in many different forms, there are shown in the drawings and will be described in detail herein several specific embodiments, with the understanding that the present disclosure is to be considered as an exemplification of the principle of the invention and is not intended to limit the invention to embodiments illustrated.

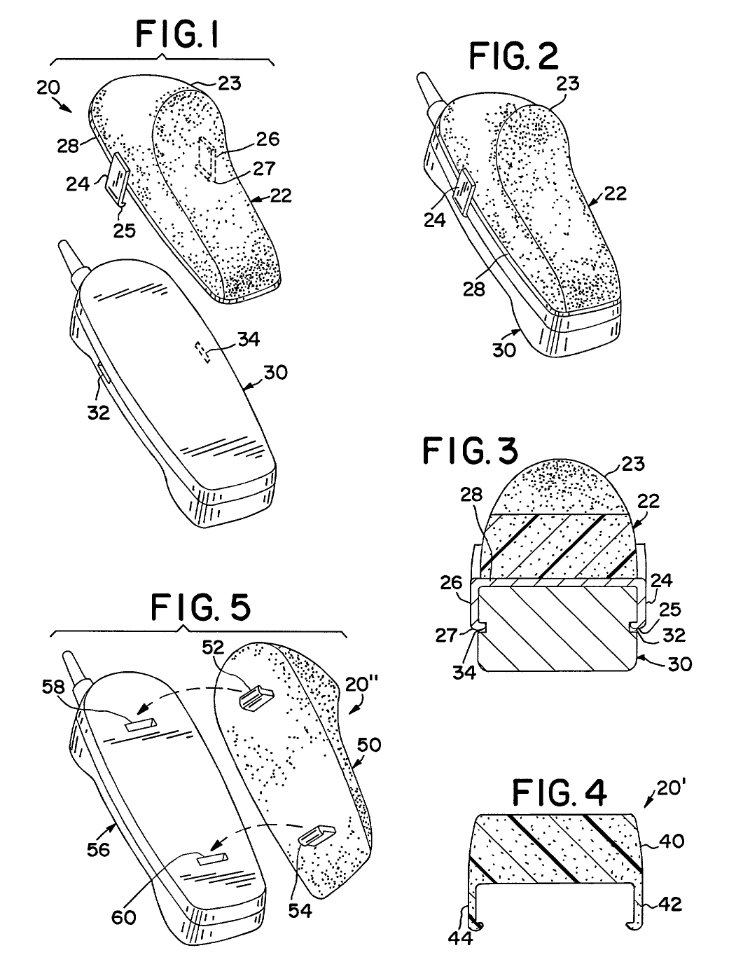

Detachable shoulder rest apparatus 20 is shown in FIGS. 1-3 as including body portion 22, arms 24 and 26, and base portion 28. In this embodiment, shoulder rest apparatus 20 is primarily designed for use with cordless telephone handsets incorporating fittings or recesses to accommodate the removable placement of external telephone accessories, such as a belt clip, although it may also be used with conventional cellular telephone handsets adapted in a similar manner. Telephone handset 30 is shown in FIGS. 1-3 as including slots 32 and 34 for the removable placement of external telephone accessories, as described below. In the embodiment illustrated, slots 32 and 34 are incorporated into the mold line which defines the joining of the upper and lower halves of telephone handset housing. Alternatively, slots 32 and 34 could be formed into other locations along the sides of telephone handset 30.

Body portion 22 is shown as comprising a contoured wedge shape 23, which substantially conforms to the shape of a user's shoulder. Body portion 22 may be made from either a deformable material or a rigid material and may be formed to toke on other shapes which serve to facilitate the comfortable holding of the telephone handset 30 when supported by the user's shoulder.

Arms 24 and 26 are shown in FIG. 3 as comprising an “L” shape, with tips 25 and 27 that are perpendicular to the remainder of arms 24 and 26. Arms 24 and 26 are preferably constructed of plastic or other similar flexible material which will allow arms 24 and 26 to bend outward and then return to their original position when a bending force is removed so as to facilitate a friction fit between shoulder rest apparatus 20 and phone 30.

Shoulder rest apparatus 20 is shown in FIG. 1 separated from telephone handset 30. The user joins shoulder rest apparatus 20 and telephone handset 30 by positioning shoulder rest apparatus 20 directly above telephone handset 30 such that arms 24 and 26 encounter the sides of telephone handset 30 and are bent outward slightly. The user then pushes shoulder rest apparatus 20 and telephone handset 30 together, so that tips 25 and 27 encounter slots 32 and 34, allowing arms 24 and 26 to return to their original position such that tips 25 and 27 snap into and engage slots 32 and 34. This attached configuration is shown in FIGS. 2 and 3.

Once shoulder rest apparatus 20 and telephone handset 30 are attached, they will remain so by the force exerted by arms 24 and 26 preventing accidental separation from one another due to the fact that tips 25 and 27 are constrained by the walls of slots 32 and 34. In order to remove shoulder rest apparatus 20 from telephone handset 30, the user bends arms 24 and 26 outward slightly so that tips 25 and 27 are removed from slots 32 and 34, and then pulls shoulder apparatus 20 away from telephone handset 30.

In the illustrated embodiment, base portion 28 is shown as a substantially flat, rigid member with body portion 22 affixed to base portion 28. However, it is contemplated that body portion 22 and base portion 28 may be constructed so as to be separable, allowing the user to remove body portion 22 while leaving base portion 28 attached to the telephone handset. This allows the user to replace body portion 22 without replacing the whole apparatus if, for example, body 22 should tear, become discolored or otherwise need replacement. Similarly, base portion 28 can be replaced should either of arms 24 and 26 be inadvertently broken. This also allows the user to attach other telephone accessories, such as belt clips, to the telephone handset by removably attaching such items to base portion 28, rather than to the handset 30 itself.

In another embodiment of the invention, detachable shoulder rest apparatus 20′ is shown in FIG. 4 as comprising body portion 40 and arms 42 and 44. In this embodiment, shoulder rest apparatus 20′ does not contain a base portion. Rather, arms 42 and 44 are an integral part of body portion 40. In this embodiment the entire integrated assembly could be fabricated of a rigid or semi-rigid material, so long as tips 25 and 27 are carried by arms 24 and 26 are retained in slots 32 and 34.

In still another embodiment of the invention, detachable shoulder rest apparatus 20″ is shown in FIG. 5 as comprising body portion 50 and arm and hook members 52 and 54. Telephone handset 56 is shown as comprising slots 58 and 60. Hook members 52 and 54 are preferably made of plastic or a similar flexible material such that hook members 52 and 54 are capable of bending outward slightly during attachment to telephone handset 56 and then returning to their original position.

In this embodiment, shoulder rest apparatus 20″ and telephone handset 56 are joined by positioning shoulder rest apparatus 20″ above telephone handset 56 such that hook members 52 and 54 are aligned with slots 58 and 60. The user then pushes shoulder rest apparatus 20″ and telephone handset 56 together, such that hook members 52 and 54 are inserted into slots 58 and 60. After such attachment, hook members 52 and 54 are constrained within slots 58 and 60, preventing accidental separation of shoulder rest apparatus 20″ and telephone handset 56. Shoulder rest apparatus 20″ may be detached by pulling shoulder rest apparatus 20″ away from telephone handset 56, thus causing hook members 52 and 54 to bend inward slightly and disengage. The user can then easily remove shoulder rest apparatus 20″.

The foregoing description and drawings are merely to explain and illustrate the inventions and the invention is not limited thereto except insofar as the independent claims are so limited, as those skilled in the art with the present disclosure before them will be able to make modifications and variations therein without departing from the scope of the invention.

What is claimed is:

1. A detachable shoulder rest apparatus for use with a telephone handset having one or more positions on the exterior of the telephone handset housing for accepting removable placement of telephone accessories, said detachable shoulder rest apparatus comprising:
a body portion configured to rest against the user's shoulder for supporting the telephone handset between the user's shoulder and head; and
at least one attachment member for engaging with the telephone handset to removably attach said body portion to the exterior of the telephone handset.

2. The detachable shoulder rest apparatus according to claim 1, wherein said body portion comprises a contoured wedge to substantially conform to the shape of the user's shoulder.

3. The detachable shoulder rest apparatus according to claim 1, wherein said body portion comprises a substantially rigid material.

4. The detachable shoulder rest apparatus according to claim 1, wherein said body portion comprises a deformable material capable of conforming to the shape of the user's shoulder.

5. The detachable shoulder rest apparatus according to claim 1, wherein said at least one attachment member comprises a plurality of arms extending from said body portion, said arms configured so as to engage at least one slot or recess located on the telephone handset.

6. The detachable shoulder rest apparatus according to claim 1, wherein said at least one attachment member comprises at least one hook member configured so as to engage at least one slot or aperture located on the telephone handset.

7. The detachable shoulder rest apparatus according to claim 1, wherein said at least one attachment member comprises at least one slot or aperture configured so as to engage at least one projection or protrusion located on the telephone handset.

8. The detachable shoulder rest apparatus according to claim 1, further comprising a base portion joining said body portion to said at least one attachment member.

9. The detachable shoulder rest apparatus according to claim 8, wherein said body portion and said base portion are separable.
